(19) United States
(12) Patent Application Publication
(10) Pub. No.: US 2025/0241235 A1
(43) Pub. Date: Jul. 31, 2025

(54) Method For Preparing To Treat Crops

(71) Applicant: Armen Vemirovich Nalbandyan, Rostov-on-Don (RU)

(72) Inventor: Armen Vemirovich Nalbandyan, Rostov-on-Don (RU)

(21) Appl. No.: 18/853,125

(22) PCT Filed: Mar. 28, 2023
(86) PCT No.: PCT/RU2023/000092

§ 371 Date: Sep. 30, 2024

(30) Foreign Application Priority Data
Mar. 31, 2022 (RU) 2022108639

(51) Int. Cl. A01C 23/00; A01C 21/00; A01M 7/00

(52) U.S. Cl. CPC A01C 23/008; A01C 21/007; A01M 7/0085

(57) ABSTRACT

The invention relates to the field of agriculture, specifically to the treatment of crops. More particularly, the invention pertains to methods and apparatus for preparing agricultural crops for processing.

Method for preparing to treat crops includes:

moving a mobile crop processing preparation device onto the field, which has a pump, liquid transfer tubes, a liquid metering system, and at least two containers, with one container filled with water and the other filled with a concentrated treatment or fertilization agent for plants. Determining the necessary concentration of the aforementioned treatment or fertilization agent for the specific field. Mixing water with the aforementioned concentrated agent in the required proportions. And transferring the resulting solution to the intended location.

The proposed invention provides for the creation of a multi-system for mixing liquids for the treatment or fertilization of plants, reduces the time required for preparing agricultural crops for processing, decreases the amount of equipment needed for this preparation, and minimizes labor costs.

### TECHNICAL FIELD

The invention relates to the field of agriculture, specifically to crop treatment. More particularly, the invention pertains to methods and devices for preparing agricultural crops for treatment.

### PRECEDING LEVEL OF TECHNOLOGY

Currently, a method for preparing to treat crops is known, in which concentrated liquids, such as pesticides, are diluted with water to the required concentration at stationary mixing units. The prepared spraying liquid is then transferred to the field by pumping it into a sprayer using a mobile pump.

This method is inefficient because the vehicle transporting the spraying liquid has limited capacity. As a result, the amount of spraying liquid may be insufficient, or, if the tank is fully loaded, excessive for the field being treated. This creates the need for either partial delivery or returning excess liquid, leading to a loss of both time and additional resources, including machinery and labor.

Another significant issue with known methods is the transportation of large volumes of water as part of the treatment solutions. Since the treatment solutions are transported in a ready-to-use form, a substantial amount of water must be hauled from a remote location to the field, even though in most cases, water is available near the field being treated.

The objective set by the developer of method for preparing to treat crops is to develop a method and device that would save time required for crop treatment preparation, reduce the amount of equipment needed for this process, and lower labor costs.

The technical result of claimed method for preparing to treat crops is the creation of a multi-system for mixing liquids for plant treatment or fertilization, saving time required for crop treatment preparation, reducing the amount of equipment needed for this process, and decreasing labor costs.

### DISCLOSURE OF INVENTION

The essence of method for preparing to treat crops consists of the following:

First, a mobile unit for preparing agricultural crops for treatment, equipped with a pump, liquid transfer hoses, a metered liquid delivery system, and at least two tanks, is transported to the field. One tank is filled with water, and the other is filled with a concentrated plant treatment or fertilization agent. The required concentration of the aforementioned treatment or fertilization agent for the specific field is then determined, after which the water is mixed with the concentrated agent in the necessary proportion, and the resulting solution is transferred to the destination.

An additional tank may also be used for the intermediate storage of water mixed with the concentrated agent, and for the subsequent delivery of the prepared solution to the destination.

If a crop treatment preparation device with 3 or more tanks is used, at least 2 of which are filled with different concentrated treatment or fertilization agents, in addition to determining the concentration, it is necessary to determine which agent or combination of agents should be used to treat the field. The water is then mixed with at least one concentrated agent, and if a combination of agents is used, the order of their mixing with the water is determined, and this sequence is followed during the mixing process.

The water and/or the concentrated agent may be heated or cooled. Additionally, before mixing with the concentrated agent, the water may be further filtered, softened, have its electrical conductivity adjusted, or be activated.

The mobile unit for preparing agricultural crops for treatment may be equipped with a location determination device and an automatic mixing control system. For a selected location corresponding to predetermined geographic coordinates, it is established in advance which agent and at what concentration should be used to treat the plants grown within the specified coordinates. Once the mobile unit is moved to the designated location, water is mixed with at least one concentrated agent with automatic adjustment of the proportions and control over the creation of a mixture of the specified consistency in a user-planned quantity.

If the tank designated for water runs empty, the pump and filtration systems of the mobile unit for preparing agricultural crops for treatment may utilize the nearest available water sources to refill the aforementioned tank with water.

The mobile unit for preparing agricultural crops for treatment may serve as a transit zone for transferring the prepared mixed solution, which was initially prepared in another mixing system.

The essence of the mobile unit for preparing agricultural crops for treatment is as follows. The device consists of:

at least 2 tanks, liquid transfer hoses connected to the aforementioned tanks, a pump connected to the hoses, a metered liquid delivery system, a chassis located at the bottom of the device, a supporting frame, wheels mounted under the chassis, and a control and management system.

The mobile unit for preparing agricultural crops for treatment may additionally include a heating and/or cooling device, a device for adjusting the electrical conductivity of water, a device for altering water hardness, a water filtration system, sensors for monitoring the liquid level in the tanks, and a mixer-activator or mixer.

### BRIEF DESCRIPTION OF THE DRAWINGS

Invention is illustrated graphically, where:

FIG. 1 shows the device for preparing agricultural crops for treatment, consisting of:
1—Pump.
2—Liquid transfer hoses.
3—Metered liquid delivery system.
4—Water tank.
5—Tank for concentrated treatment or fertilization agents.
6—Transfer hopper with built-in elements designed for the installation, securing, and transportation of a water tank frame cassette.
7—Frame cassette for water tanks.
8—Wheels.
9—Device for heating and/or cooling liquids.
10—Device for adjusting the electrical conductivity of water.

FIG. 2 shows the device for preparing agricultural crops for treatment, which is a transfer hopper featuring a body swap using attachments designed for such replacement, consisting of:
1—Pump.
2—Liquid transfer hoses.
3—Metered liquid delivery system.
4—Water tank.
5—Tank for concentrated treatment or fertilization agents.
7—Frame cassette for water tanks.
8—Wheels.
9—Device for heating and/or cooling liquids.
10—Device for adjusting the electrical conductivity of water.
11—Attachments for a removable body.
12—Chassis of the transfer hopper with built-in elements designed for the installation, securing, and transportation of the frame cassette with water tanks. (The numbering in the drawing has not yet been corrected.)

FIG. 3 shows—A cross-section view A-A of FIGS. 1 and 2.

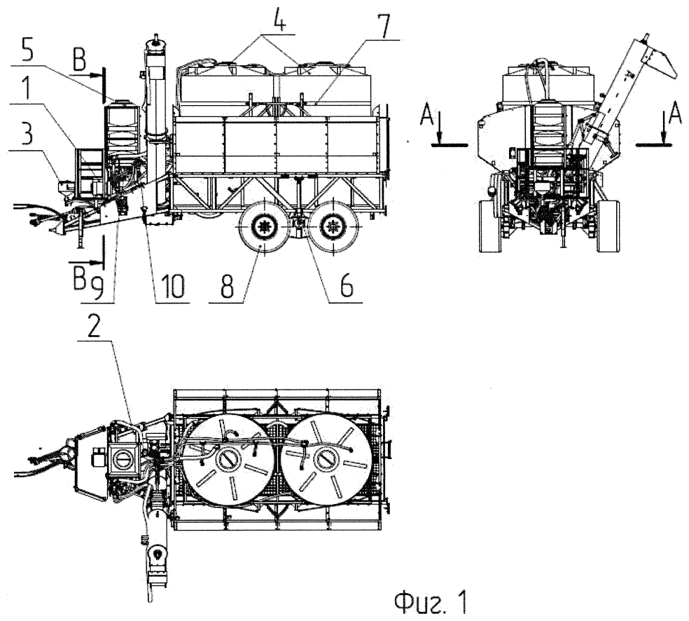

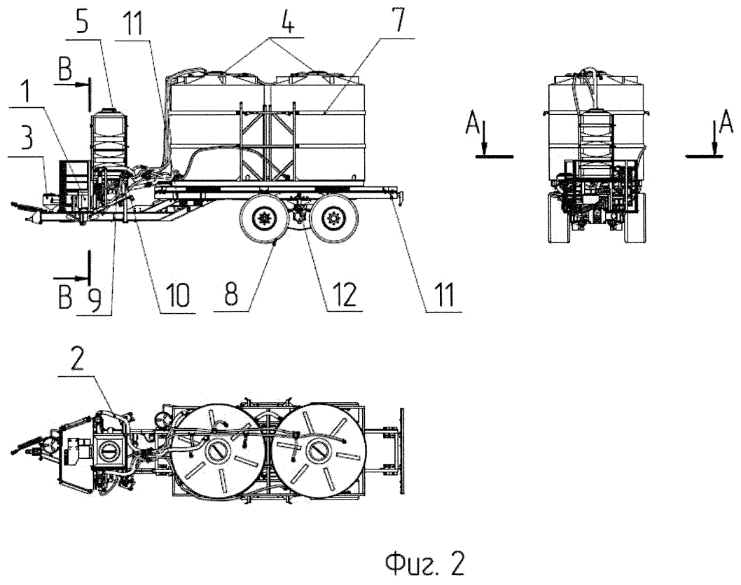

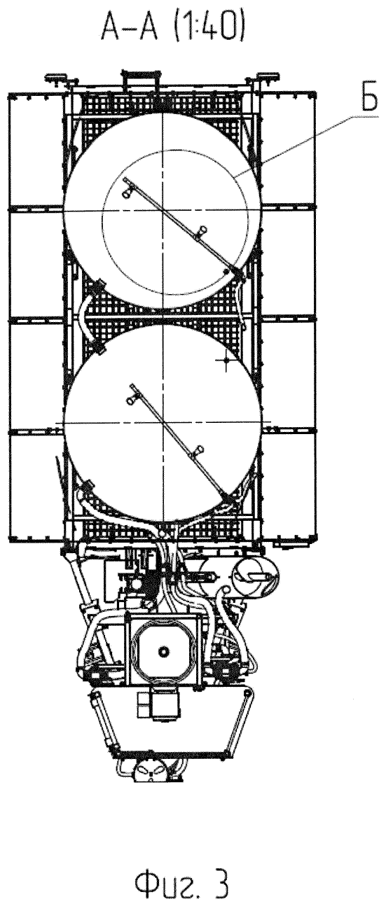

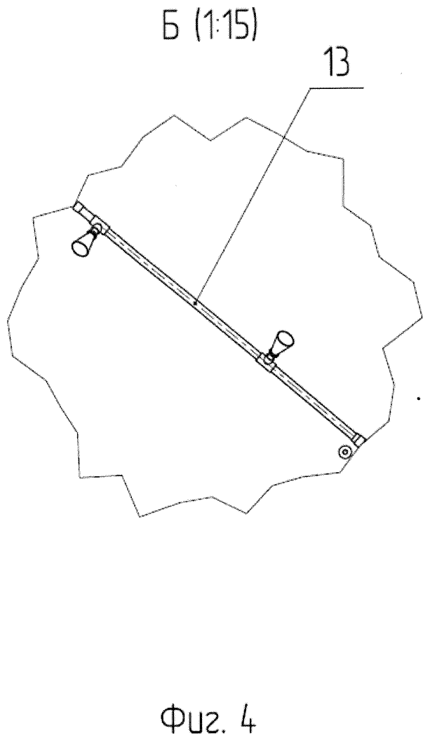

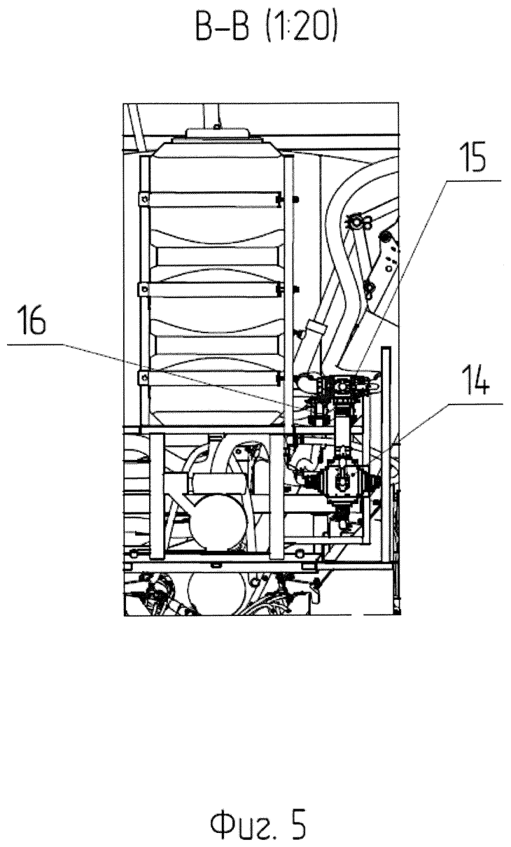

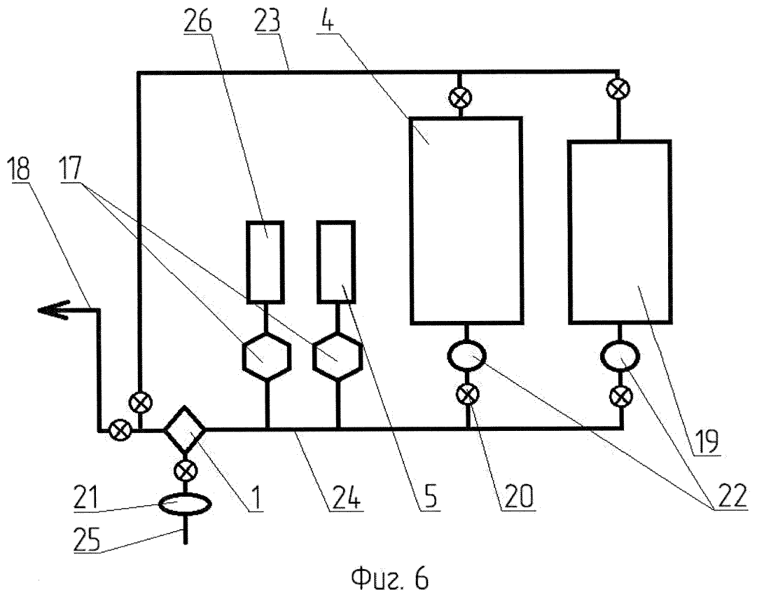

FIG. 4 shows—An auxiliary element B of FIG. 3, where the following is indicated:
13—Mixer or mixer-activator.

FIG. 5 shows—A cross-section view C-C of FIGS. 1 and 2, where the following are indicated:
14—Control and management system.
15—Device for adjusting water hardness.
16—Water filter.

FIG. 6 shows—A schematic layout of the main elements for the delivery and mixing of liquids, consisting of:
1—Pump.
4—Water tank.
5—Tank for concentrated treatment or fertilization agents.
17—Pump-metering device.
18—Hose for transferring liquid to the destination.
19—Mixing and/or intermediate storage tank for the ready-to-use solution.
20—Valves.
21—Filter.
22—Dispensers.
23—Hose for transferring liquids from the pump to the tanks.
24—Hose for transferring liquids from the tanks to the pump.
25—Hose for drawing liquids from available sources.
26—Additional tank for concentrated treatment or fertilization agents.

### EXAMPLE OF A SPECIFIC APPLICATION OF THE INVENTION

The claimed mobile unit for preparing agricultural crops for treatment consists of: at least two tanks, liquid transfer hoses connected to the aforementioned tanks, a pump (hereinafter referred to as pump 1) connected to the hoses, a metered liquid delivery system for supplying the concentrated treatment or fertilization agent to the location where it will be mixed with water, a chassis located at the bottom of the device, a supporting frame, wheels mounted under the chassis, and a control and management system.

Such a device, for example, may be a self-propelled machine if it has its own engine, or a trailer that can be transported using other vehicles or tractors. The device may have multiple tanks, but the minimum number of tanks is two, one of which is intended to be filled with water and the other with a concentrated agent. If there are three or more tanks, the additional tanks (besides the two mentioned above) may also be designated for filling with water or concentrated agents.

The metered liquid delivery system may consist of, for example, multiple valves that block the movement of liquid through the hoses, and metering pumps, with each tank containing an agent having its own dedicated metering pump. Instead of metering pumps, peristaltic pumps or gear pumps may be used, in which case valves may not be required.

For example, the metered liquid delivery system, as shown in FIG. 3, may consist of multiple valves 20 and a pump-metering device 17, with each tank containing an agent 5 and 16 having at least one pump-metering device 17. Such a system may operate as follows, for example.

As an example, let us describe how the metered delivery of liquids is performed using a system with one tank filled with water 4, one tank filled with a concentrated agent 5, and an additional tank 19, into which the mixed liquid is delivered and where the resulting solution is stored. The pump-metering device 17 is located beneath the tank containing the concentrated agent 5 and ensures the metering and delivery of the concentrated agent into hose 24, where it is picked up by the water flow and transported by pump 1 through hose 23 into tank 19. Additionally, tank 19 may be equipped with devices for mixing the liquids.

The water supply can be regulated using a dispenser or metering pump to maintain the correct proportions of the mixed components. The resulting solution can then be pumped by pump 1 from tank 19 through hoses 24 and 18 to the destination. For example, if a concentrated pesticide was mixed with water as the concentrated agent, the destination to which the resulting solution is pumped could be a sprayer. If it is necessary to create a combination of different agents, after dispensing the concentrated agent from tank 5, the agent from tank 16 can be added. In cases where sequential dispensing is unacceptable and only stepwise mixing is possible, the water and concentrated agent are first mixed according to the scheme described above, with the resulting solution being transferred to tank 19. Then, after the water supply from tank 4 is closed, the partially prepared mixture is dispensed into hose 24 from tank 19 with the required dosage, as described above, and the concentrated agent from tank 16 is added with the required dosage using pump-metering device 17.

Pump 1 transfers the resulting solution to tank 19, creating recirculation and mixing the liquid with the second agent during operation. In this way, water can be mixed stepwise with various agents, preventing direct contact between the concentrated agents before they are mixed with water.

Pump 1 in such a device performs four main functions:
1. Drawing water into the water tank 4 from reservoirs, wells, or from vehicle or tractor tanks—if water is supplied to the field using these methods;
2. Transferring water from the water tank through hoses;
3. Mixing water and concentrated agents to the required consistency during the transfer of water and the concentrated agent, creating a solution with the user-specified properties;
4. Discharging the prepared solution to the destination, such as into a sprayer.

Examples of metering devices may include, for instance, metering pumps, peristaltic pumps, etc. The aforementioned mobile unit for preparing agricultural crops for treatment may be, for example, a transfer hopper on which all the aforementioned components of the mobile unit for preparing agricultural crops for treatment are installed.

The transfer hopper may have several methods for installing these devices:
1. Elemental assembly method, where the transfer hopper allows for the installation of necessary tanks, water pump(s), metering pump(s), and hoses in the corresponding locations of the transfer hopper structure;
2. Integrated cassette method, where a functional design assembled into a single cassette is installed and securely fixed onto special supporting brackets inside the transfer hopper;
3. Replaceable body method, where a functional design assembled into a single cassette is mounted on the supporting brackets of the transfer hopper chassis after the prior removal of the transfer hopper's body, ensuring secure installation and fastening.

As concentrated agents for the treatment or fertilization of plants, various concentrated agents may be used depending on the purpose of the treatment, including disease and insect control agents, growth stimulants, concentrated liquid fertilizers, etc.

Additionally, the mobile unit for preparing agricultural crops for treatment may include devices for heating and/or cooling, devices for altering the electrical conductivity of water, devices for changing the hardness of water, water filtration devices, a mixer-activator or mixer, and sensors for monitoring liquid levels in the tanks.

Such devices are well known in the art and do not require detailed description. For example, water heaters operating on liquid or gaseous fuel can be used for heating water. If the device is designed for both heating and cooling liquids, a Peltier element may be utilized, for instance. To alter the electrical conductivity of water, devices employing methods such as reverse osmosis, electrodeionization, ion exchange, etc., can be used. Water softeners may be employed to reduce water hardness, while various types of filters designed for purifying flowing liquids can be used for water purification. An electromagnetic mixer-activator can serve as a mixer-activator, for example.

The claimed method for preparing agricultural crops for treatment involves the following steps.

First, a mobile unit for preparing agricultural crops for treatment is transported to the field, equipped with a pump, hoses for moving liquids, a metering liquid delivery system, and at least two tanks, where one tank is filled with water and the other with a concentrated agent for treatment or fertilization of plants. Next, the required concentration of the agent for treating the field is determined, after which water is mixed with the concentrated agent in the necessary proportions, and the prepared solution is transferred to the destination, such as a sprayer.

Additionally, if concentrated agents, such as concentrated pesticides, are used, it is important to understand within the framework of this invention that concentrated pesticides refer to both high-concentration toxins and mother solutions that are diluted with water but still maintain a concentration higher than that required for spraying.

Additionally, a mobile unit for preparing agricultural crops for treatment may be used, which has three or more tanks, at least two of which are filled with different concentrated agents. In this case, in addition to determining the concentration, the specific agent or combination of agents required for treating the field is identified. Following this, water is mixed with at least one concentrated agent in the necessary proportions. This solution enables the creation of various combinations of agents with different concentrations.

When two or more agents are mixed with water, the sequence of mixing the agents with water is also determined, and this mixing sequence is adhered to during the mixing process. An example of how water can be mixed with a concentrated agent is described above in the section regarding the metering liquid delivery system.

The specific agent or combination of agents and their required concentrations for each particular field are determined by an agronomist.

After the water in the tank designated for water is depleted, the mobile unit for preparing agricultural crops for treatment can utilize natural water bodies or other available water sources to refill the aforementioned tank with water. For this purpose, a water pump and a valve system are used to open or close various channels for water movement, depending on the task at hand. For example, to supply water from a water body, the valve is switched to the position where the supply from the water tank is closed, and the channel from external sources is opened. Regarding the discharge section, the pumped water is directed into the tank where the discharge channel is open, controlled by the valve system, as shown in FIG. 3.

The mobile unit for preparing agricultural crops for treatment may be additionally equipped with a location determination device and an automatic mixing control system. For a selected location corresponding to predetermined geographical coordinates, the specific agent and its concentration required for treating the plants grown within the aforementioned coordinates are predetermined. After the mobile unit for preparing agricultural crops is moved to the specific location, water is mixed with at least one concentrated agent with automatic adjustment of proportions and control over the creation of a mixture with the specified consistency in a quantity pre-planned by the user.

Water and/or the concentrated agent can also be heated or cooled. Additionally, the water may be filtered, softened, and its electrical conductivity modified. These actions may be necessary to achieve the most efficient and economical solutions. The required temperature, hardness, and other parameters for preparing each specific solution are determined by the preparation technology for that particular solution.

The mobile device for preparing agricultural crops can also be used as a transit zone for transferring the ready solution. For example, a tanker may deliver the ready solution for spraying, and the mobile device for preparing agricultural crops transfers the ready solution into its tanks and, as needed, pumps the ready liquid into the sprayer in portions. Meanwhile, the tanker can return for a new batch of the ready liquid.

Additionally, parameters of the water, such as hardness, electrical conductivity, and contamination levels, can be determined at water sources located in close proximity to the fields that need to be sprayed. The measurements obtained from samples of water taken from these water bodies can be recorded in a computer. If it becomes necessary to use water from these sources, the user will be able to select the best solution.

### INDUSTRIAL APPLICABILITY

By conducting the mixing of the concentrated agent with water directly in the field, and given that water is a resource that can be replenished from nearby natural sources, the mobile device for preparing agricultural treatments can provide a higher volume of solutions ready for application or fertilization without the need to return to a warehouse or other production site for the liquid. This results in significant time savings required for preparing treatments or fertilizing plants and eliminates the need to transport water over long distances, as it can typically be sourced from locations closer to the crops being treated, such as natural water bodies or wells. The capability to mix concentrated agents with water in varying concentrations facilitates the creation of a poly-system for mixing liquids for the treatment or fertilization of plants.

By integrating the device that mixes water with concentrated agents and the machine that transports ready-to-spray solutions into a single unit, the need for multiple pieces of equipment for preparing treatments or fertilizing agricultural crops is reduced. This also saves time, as there is no need to wait for the mixing of concentrated agents with water.

The reduction in the number of machines required for preparing treatments or fertilizing agricultural crops is also achieved by the capability to mix several different concentrated agents with water for various fields that require different ready-to-use solutions for treatment or fertilization. In this case, there is no need to use multiple vehicles to transport various prepared solutions for the treatment or fertilization of agricultural crops.

1. Method for preparing to treat crops, wherein a mobile preparation device equipped with a pump, fluid transfer tubes, a liquid dosing system, an intermediate storage tank for the prepared solution, and at least two additional tanks—one filled with water and the other with a concentrated agent for treating or fertilizing plants—is first moved to the field, followed by determining the agent or combination of agents needed to treat the specific field and the required concentration of said agent or agents for treating or fertilizing the plants, after which water is mixed with at least one concentrated agent in the necessary proportions and the resulting solution is transferred to the destination, with the sequence of mixing the agents with water being determined and adhered to if a combination of agents is used.

2. Method for preparing to treat crops, based on claim 1, wherein heating or cooling the water and/or the concentrated agent.

3. Method for preparing to treat crops, based on claim 2, wherein additionally filtering, softening, altering the conductivity, and activating the water prior to mixing with the concentrated agent.

4. Method for preparing to treat crops, based on claim 3, wherein equipping the mobile device for preparing agricultural crops with a location determination device and an automatic mixing control system, wherein for a selected location corresponding to predetermined geographic coordinates, it is predefined which agent and at what concentration should be used to treat the plants grown within the specified coordinates, and after the mobile device is moved to the specific location, water is mixed with at least one concentrated agent with automatic adjustment of proportions and control of creating a mixture of specified consistency in a user-planned quantity.

5. Method for preparing to treat crops, based on claim 4, wherein utilizing the nearest available water sources to refill the water reservoir after it is depleted using the pumping and filtration systems of the mobile device for preparing agricultural crops.

6. Method for preparing to treat crops, based on claim 5, wherein using the mobile device for preparing agricultural crops as a transit zone for pumping the prepared solution.
